(19) United States
(12) Patent Application Publication
(10) Pub. No.: US 2009/0063355 A1
(43) Pub. Date: Mar. 5, 2009

(54) METHOD AND SYSTEM USING RELOADABLE PORTABLE CONSUMER DEVICES

(76) Inventors: Nizam Antoo, San Carlos, CA (US); Tim Boccia, Pacifica, CA (US); Todd Brockman, Kentfield, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 11/848,475

(22) Filed: Aug. 31, 2007

(51) Int. Cl. G06Q 40/00

(52) U.S. Cl. 705/78; 235/379; 705/41; 705/43; 705/44

(57) ABSTRACT

A method is disclosed. The method includes providing tender at an automatic teller machine (ATM), where the automatic teller machine is in operative communication with a payment processing network. The automatic teller machine sends a transaction authorization request message to an issuer of a portable consumer device, and the issuer authorizes or does not authorize the transaction authorization request message.

### CROSS-REFERENCES TO RELATED APPLICATIONS

None.

### BACKGROUND OF THE INVENTION

Prepaid card products have achieved a critical level of industry, marketplace and consumer acceptance and usage. They can now be considered a stand-alone payment category. The growth of these cards and related transaction volumes has been accelerated by the emergence of new participants (issuers and processors). The new participants use non-standard platforms, applications, devices and connectivity protocols. Despite the increased number of participants, the non-standard implementations of such prepaid card systems by the various new participants have actually limited the broad-based usage (activation, load and settlement) of such prepaid card products.

One commonly used prepaid card is the Starbucks™ card. The Starbucks™ card can be loaded or reloaded with value, but only in Starbucks™ stores. The Starbucks™ prepaid card cannot be used in other stores such as grocery stores.

Another type of conventional prepaid card can be used at different merchants, and is initially purchased at a store. Money is paid to the store clerk and the consumer takes the card home. To load the card, the consumer calls a phone number to load the card and to link the load transaction to the card. The money is moved a few days (typically 2-5 days) later to the issuer of the card and the card is ready for use.

There are also a number of drawbacks associated with this type of transaction. First, the clearing and settlement process takes a fairly significant amount of time. As noted above, the clearing and settlement process can take between 2 and 5 days, which is quite long. Second, the activation process for the prepaid card is quite complex. Multiple steps are needed just to activate the card. Third, for each merchant that wants to participate in the system, a separate data feed needs to be established between the merchant and the system. This is cumbersome and costly and limits participation in the system.

In addition, it is not always convenient for the user to load a card with value, since participating merchants may not be ubiquitous. It would be desirable to make it easier and more convenient for a user to load or reload a card or other type of portable consumer device with value.

Embodiments of the invention address the above problems, and other problems, individually and collectively.

### SUMMARY OF THE INVENTION

Embodiments of the invention are directed to methods and systems that allow for the initial loading and/or reloading of portable consumer devices with value, using a payment processing network that is configured to process credit and debit card transactions.

One embodiment of the invention is directed to a method comprising: providing tender at an automatic teller machine (ATM), the automatic teller machine being in operative communication with a payment processing network, wherein the automatic teller machine thereafter sends a transaction authorization request message to an issuer of a portable consumer device to be used by a user and wherein the issuer thereafter authorizes or does not authorize the transaction authorization request message; receiving at the automatic teller machine, an indication that the transaction authorization request message has been approved or not approved; and if the transaction authorization request message has been approved, the portable consumer device is either initially loaded or reloaded with an amount associated with the tender provided at the automatic teller machine.

Another embodiment of the invention is directed to a method comprising: sending a transaction authorization request message to an issuer of a portable consumer device to be used by a user from an automatic teller machine (ATM) after receiving tender from a user, wherein the issuer thereafter authorizes or does not authorize the transaction authorization request message, and wherein the automatic teller machine is in operative communication with a payment processing network; receiving at the automatic teller machine, an indication that the transaction authorization request message has been approved or not approved; and if the transaction authorization request message has been approved, the portable consumer device is either initially loaded or reloaded with an amount associated with the tender provided at the automatic teller machine.

Another embodiment of the invention is directed to a method comprising: receiving a transaction authorization request message associated with a portable consumer device to be used by a user from an automatic teller machine (ATM), wherein an issuer of the portable consumer device thereafter authorizes or does not authorize the transaction authorization request message, and wherein the automatic teller machine is in operative communication with a payment processing network; and sending a transaction response message to the automatic teller machine, wherein the transaction response message indicates whether or not the transaction authorization request message is approved or not approved.

These and other embodiments of the invention are described in further detail below.

### BRIEF DESCRIPTION OF THE DRAWINGS

FIG. 1. shows a block diagram of components that can be present in a system according to an embodiment of the invention.

FIG. 2 shows a block diagram showing components of a portable consumer device in the form of a phone.

FIG. 3 shows a plan view of a portable consumer device in the form of a card.

FIG. 4 shows a block diagram of some components in an ATM.

FIG. 5 shows a flowchart illustrating methods according to embodiments of the invention.

### DETAILED DESCRIPTION

Certain ATMs being deployed today include bulk note acceptors that allow for an ATM to accept and verify cash deposits without human intervention. Such ATMs can be used with a payment processing network to perform load transactions associated with portable consumer devices such as prepaid cards. Such transactions may include initially loading or re-loading portable consumer devices with value. For example, a user such as a consumer may want to increase the value of the user's prepaid card by $100. The user may insert $100 into an ATM after selecting a load transaction.

As with other optional services offered at ATMs, an ATM acquirer can use flags in a BIN (bank identification number) file to determine which portable consumer devices are participating in the load or reload service according to embodiments of the invention. The ATM acquirer can format the load transaction as it would any other ATM transaction (SMS or single message format) with the exception of populating the processing code with a predetermined value (e.g., “28”) which is defined by the payment processing network as a load transaction.

After tender is provided to the ATM, a transaction authorization request message could be sent to the issuer. Once the transaction authorization request message is received, and the transaction is approved by the issuer, the issuer can credit the user's account immediately. Because these transactions can take place through ATMs with bill readers (and bulk note acceptors in some cases), the issuer can be assured of good, clear funds and can credit the cardholder immediately. Since these transactions can use SMS messages, they can be processed in real time.

As used herein, “loading” includes loading and reloading value onto portable consumer devices. As will be explained in detail below, this can be done by crediting an account associated with the portable consumer device. In some embodiments, a prepaid card can be loaded or reloaded with value. In other cases, even credit cards can be loaded with value (credited) using embodiments of the invention. For example, a consumer may have a credit card with a balance, and the consumer may put money into an ATM to thereby reduce the outstanding balance on the credit card.

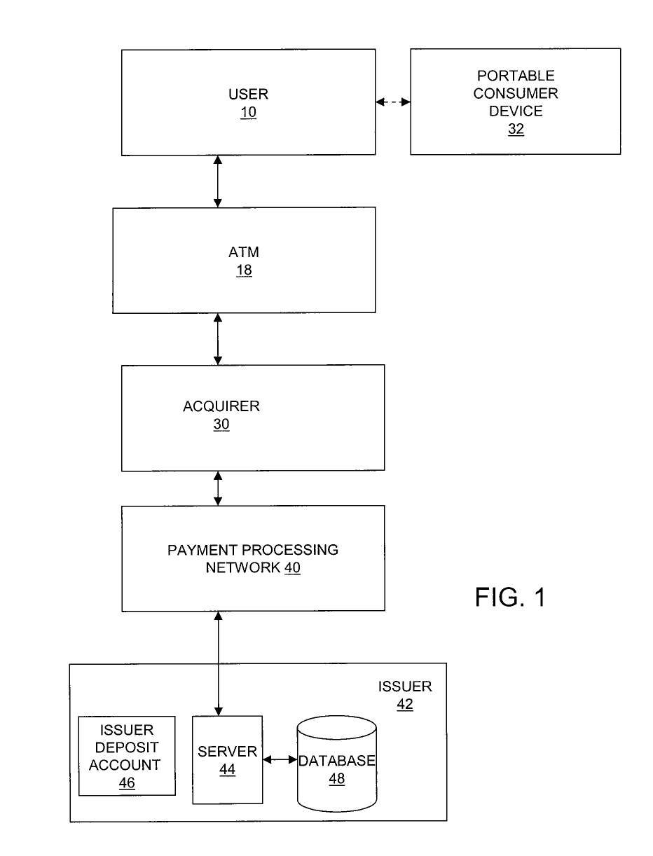

FIG. 1 shows a system according to an embodiment of the invention. Other systems according to embodiments of the invention may include fewer or more components than are specifically shown in FIG. 1.

FIG. 1 shows a user 10, an ATM 18, an acquirer 30, a payment processing network 40, and an issuer 42, in operative communication with each other. The acquirer 30 and issuer 42 can communicate through the payment processing network 40.

The user 10 may also be a consumer of goods and/or services. The user 10 may be associated with (e.g., use) a portable consumer device 14 such as a prepaid card.

Although prepaid cards are discussed in detail, embodiments of the invention may encompass more than just prepaid cards. Embodiments of the invention may include any suitable portable consumer device. For example, the portable consumer devices can be hand-held and compact so that they can fit into a consumer's wallet and/or pocket (e.g., pocket-sized). Examples of portable consumer devices may include cellular phones, personal digital assistants (PDAs), pagers, payment cards, payroll cards, security cards, access cards, smart media, transponders, and the like. The portable consumer devices may interface with point of service (POS) terminals using any suitable mechanism including any suitable electrical, magnetic, or optical interfacing system. For example, a contactless system such as an RF (radio frequency) device recognition system or contact system such as a magnetic stripe may be used to interface with a POS terminal containing a contactless reader or a magnetic stripe reader, respectively. Suitable cards may include prepaid cards, stored value cards, gift cards, payroll cards, etc.

The portable consumer device 32 may include a volatile or non-volatile memory to store information such as the cardholder's primary account (PAN) number, name, and other information. Load value data may also be stored in the memory in the portable consumer device 32. Alternatively or additionally, load value data may be stored in a database 48 associated with the issuer 42 along with the account number associated with the portable consumer device 32. Changing monetary values associated with the portable consumer device 32 may be retained solely in the database 48 so that the portable consumer device 14 could simply store basic information including the account number associated with the portable consumer device 32.

As shown in FIG. 1, the system may include an acquirer 30 and an issuer 42. The acquirer 30 may be a bank that is associated with the ATM 18. The issuer 42 may have a server computer 44, as well as a database 48, and at least one issuer deposit account 46.

The server computer 44 is typically a powerful computer or cluster of computers. For example, the server computer can be a large mainframe, a minicomputer cluster, or a group of servers functioning as a unit. In one example, the server computer may be a database server coupled to a web server.

The server computer 44 may also comprise a processor, and a computer readable medium. The computer readable medium may include code or instructions for receiving a transaction authorization request message associated with a portable consumer device to be used by a user from an automatic teller machine (ATM), wherein an issuer of the portable consumer device thereafter authorizes or does not authorize the transaction authorization request message, and wherein the automatic teller machine is in operative communication with a payment processing network, and code or instructions for sending a transaction response message to the automatic teller machine, wherein the transaction response message indicates whether or not the transaction authorization request message is approved or not approved. It may also include code or instructions for crediting an account associated with the portable consumer device 32 after the issuer 42 approves of the transaction.

As used herein, an “acquirer” is typically a business entity, e.g., a commercial bank that has a business relationship with a particular merchant or an ATM. An “issuer” is typically a business entity (e.g., a bank) which issues a portable consumer device such as a credit or debit card to a consumer. Some entities can perform both issuer and acquirer functions. Embodiments of the invention encompass such single entity issuer-acquirers.

The payment processing network 40 may comprise or use a payment processing network such as VisaNet™. The payment processing network 40 and any communication network that communicates with the payment processing network 40 may use any other suitable wired or wireless network, including the Internet. The payment processing network 40 may be adapted to process ordinary debit or credit card transactions, in addition to processing transactions associated with the loading and/or reloading of value on portable consumer devices.

For simplicity of illustration, one user 10, one ATM 18, one acquirer 30, and one issuer 42 are shown. However, it is understood that in embodiments of the invention, there can be multiple users, ATMs, issuers, as well as server computers, deposit accounts, etc.

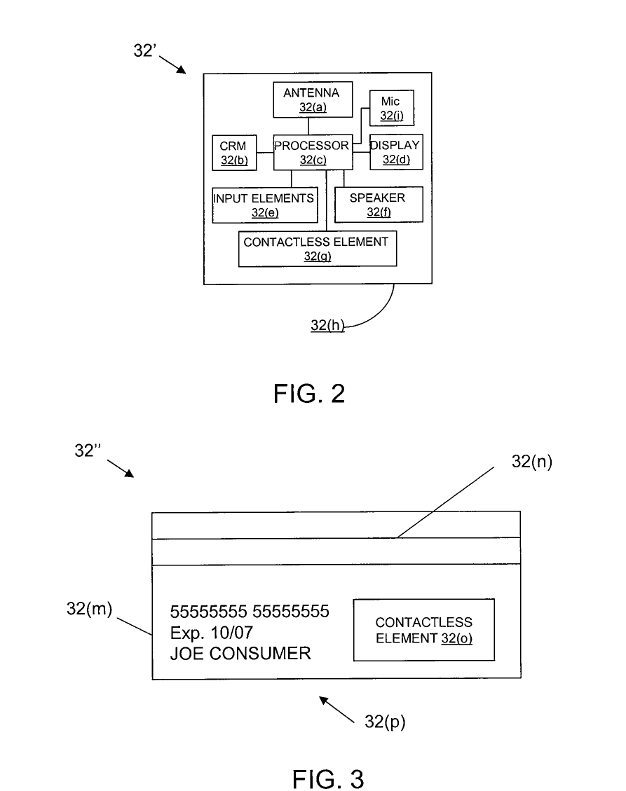

An exemplary portable consumer device 32′ in the form of a phone may comprise a computer readable medium and a body as shown in FIG. 2. (FIG. 2 shows a number of components, and the portable consumer devices according to embodiments of the invention may comprise any suitable combination or subset of such components.) The computer readable medium 32(b) may be present within the body 32(h), or may be detachable from it. The body 32(h) may be in the form a plastic substrate, housing, or other structure. The computer readable medium 32(b) may be a memory that stores data and may be in any suitable form including a magnetic stripe, a memory chip, etc. The memory preferably stores information such as financial information, transit information (e.g., as in a subway or train pass), access information (e.g., as in access badges), etc. Financial information may include information such as bank account information, bank identification number (BIN), credit or debit card number information, account balance information, expiration date, consumer information such as name, date of birth, etc. Any of this information may be transmitted by the portable consumer device 32′.

In some embodiments, and regardless of the type of portable consumer device that is used, information in the memory may also be in the form of data tracks that are traditionally associated with credits cards. Such tracks include Track 1 and Track 2. Track 1 (“International Air Transport Association”) stores more information than Track 2, and contains the cardholder's name as well as account number and other discretionary data. This track is sometimes used by the airlines when securing reservations with a credit card. Track 2 (“American Banking Association”) is currently most commonly used. This is the track that is read by ATMs and credit card checkers. The ABA (American Banking Association) designed the specifications of this track and all world banks must abide by it. It contains the cardholder's account, encrypted PIN, plus other discretionary data.

The portable consumer device 32′ may further include a contactless element 32(g), which is typically implemented in the form of a semiconductor chip (or other data storage element) with an associated wireless transfer (e.g., data transmission) element, such as an antenna. Contactless element 32(g) is associated with (e.g., embedded within) portable consumer device 32′ and data or control instructions transmitted via a cellular network may be applied to contactless element 32(g) by means of a contactless element interface (not shown). The contactless element interface functions to permit the exchange of data and/or control instructions between the mobile device circuitry (and hence the cellular network) and an optional contactless element 32(g).

Contactless element 32(g) is capable of transferring and receiving data using a near field communications (“NFC”) capability (or near field communications medium) typically in accordance with a standardized protocol or data transfer mechanism (e.g., ISO 14443/NFC). Near field communications capability is a short-range communications capability, such as RFID, Bluetooth™, infra-red, or other data transfer capability that can be used to exchange data between the portable consumer device 32′ and an interrogation device. Thus, the portable consumer device 32′ is capable of communicating and transferring data and/or control instructions via both cellular network and near field communications capability.

The portable consumer device 32′ may also include a processor 32(c) (e.g., a microprocessor) for processing the functions of the portable consumer device 32′ and a display 32(d) to allow a consumer to see phone numbers and other information and messages. The portable consumer device 32′ may further include input elements 32(e) to allow a consumer to input information into the device, a speaker 32(f) to allow the consumer to hear voice communication, music, etc., and a microphone 32(i) to allow the consumer to transmit her voice through the portable consumer device 32′. The portable consumer device 32′ may also include an antenna 32(a) for wireless data transfer (e.g., data transmission).

If the portable consumer device is in the form of a debit, credit, or smartcard, the portable consumer device may also optionally have features such as magnetic strips. Such devices can operate in either a contact or contactless mode.

An example of a portable consumer device 32″ in the form of a card is shown in FIG. 3. FIG. 3 shows a plastic substrate 32(m). A contactless element 32(o) for interfacing with an access device 34 may be present on or embedded within the plastic substrate 32(m). Consumer information 32(p) such as an account number, expiration date, and consumer name may be printed or embossed on the card. Also, a magnetic stripe 32(n) may also be on the plastic substrate 32(m).

As shown in FIG. 3, the portable consumer device 32″ may include both a magnetic stripe 32(n) and a contactless element 32(o). In other embodiments, both the magnetic stripe 32(n) and the contactless element 32(o) may be in the portable consumer device 32″. In other embodiments, either the magnetic stripe 32(n) or the contactless element 32(o) may be present in the portable consumer device 32″.

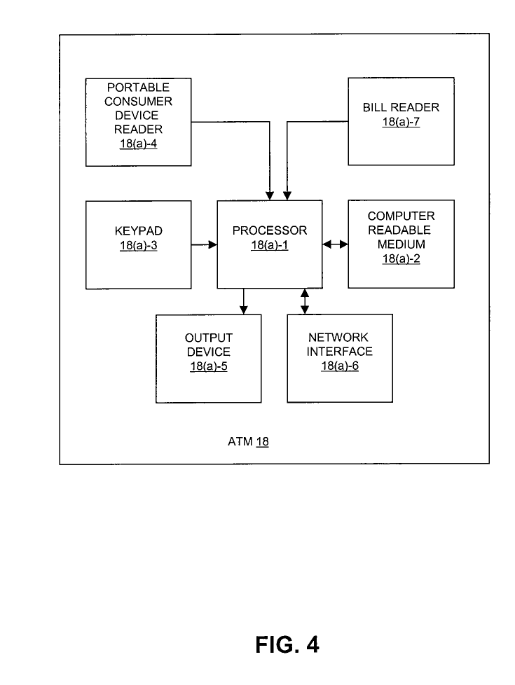

FIG. 4 shows a block diagram showing basic components that may reside in an ATM 18. An exemplary ATM may comprise a processor 18(a)-1. a computer readable medium 18(a)-2, a keypad 18(a)-3, a portable consumer device reader 18(a)-4, an output device 18(a)-5, a network interface 18(a)-6, and a bill reader 18(a)-7 for reading bills, can all be operatively coupled to the processor 18(a)-1. Exemplary portable consumer device readers can include RF (radio frequency) antennas, magnetic stripe readers, etc. that interact with the portable consumer device 32. Suitable output devices may include displays and audio output devices. Exemplary computer readable media may include one or more memory chips, disk drives, etc.

The computer readable medium 18(a)-2 may store code for instructions that will allow the ATM to operate. The instructions may be executed by the processor 18(a)-1. For example, the computer readable medium 18(a)-2 may comprise code or instructions for sending a transaction authorization request message to an issuer of a portable consumer device to be used by a user from an automatic teller machine (ATM) after receiving tender from a user, wherein the issuer thereafter authorizes or does not authorize the transaction authorization request message, and wherein the automatic teller machine is in operative communication with a payment processing network, and code or instructions for receiving at the automatic teller machine, an indication that the transaction authorization request message has been approved or not approved. The computer readable medium may also have code or instructions for accepting tender and for automatically determining the amount of the accepted tender.

The bill reader 18(a)-7 is capable of reading bills and distinguishing the value of the bills. It can determine if the user 10 has inserted, for example, a $20 or $100 bill into the ATM 18. The bill reader 18(a)-7 may be more generically referred to as a tender reader. Tender readers may include bill readers, check readers, coin readers, etc. Tender readers can determine the value of tender that a user has inserted into the ATM.

The network interface 18(a)-6 may allow the ATM 18 to send and receive messages from the acquirer 30, payment processing network 40, and/or the issuer 42.

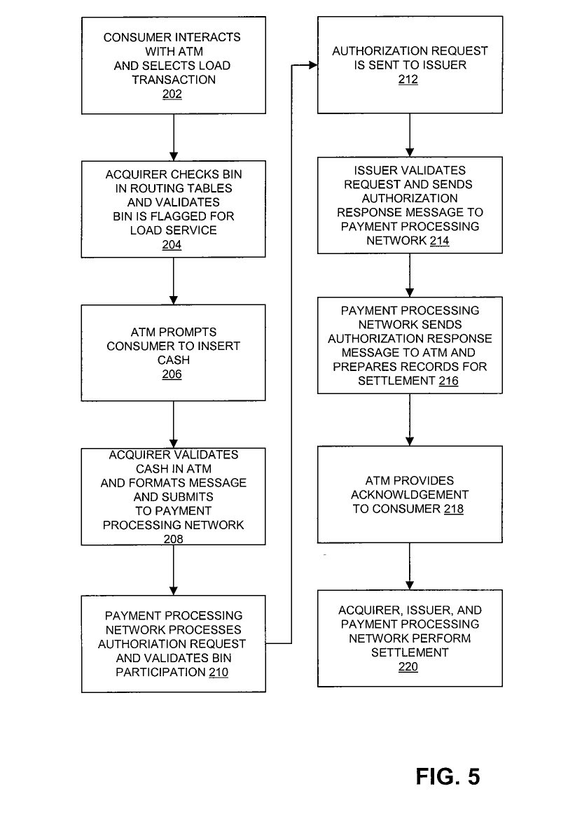

Methods according to embodiments of the invention can be described with reference to FIGS. 1 and 5.

A user 10 may take his portable consumer device 32 and may use it to interact with an ATM 18 (step 202). For example, the portable consumer device 32 may be in the form of a payment card. The user 10 may insert the portable consumer device 32 into the ATM 18, and then selects a load transaction option using a keypad 18(a)-3 in the ATM or other input device. This option may be presented to the user 10 via an output device 18(a)-5 (e.g., a display) in the ATM 18. The portable consumer device reader 18(a)-4 may then read data from the portable consumer device 32. Data that is read from the portable consumer device 32 includes a BIN (bank identification number), expiration date, etc.

Then, the acquirer 30 can check BINs (bank identification numbers) in the routing tables and validates that the BIN is flagged for load service (step 204). The ATM acquirer 30 has the ability to know whether or not the card is a portable consumer device that participates in the load process, based on BIN routing tables. The BIN routing tables may be stored at any suitable location including at the ATM 18, the acquirer 30, and the payment processing network 40. The ATM 18 may check to see if the portable consumer device 32 participates in the load process using the BIN routing tables.

After the BINs in the routing tables have been checked, the ATM 18 prompts the user 10 to insert tender (e.g., cash) into the ATM (step 208). The user 10 may insert $10 bills, $20 bills, $50 bills, etc. into the ATM 18, and the ATM 18 (using the bill reader 18(a)-7, the processor 18(a)-1, and the computer readable medium 18(a)-2) can determine how much money that the user 10 has inserted into the ATM 18.

After the ATM receives the tender, the acquirer 30 validates the cash in the ATM 10 and formats a transaction authorization request message and submits the message to the payment processing network 40 (step 208) using the network interface 18(a)-6. The request message may comprise data elements including a surcharge amount (optional), an account number, a processing code (indicating that the transaction is a load transaction), a load amount, an expiration date for the portable consumer device 32, a network ID (indicating that which network is intended to process the transaction), reimbursement data (e.g., whether the acquirer 30 or a merchant shares fees with the issuer 42) and a merchant category code. The merchant category code may be, for example, “6011” which may indicate that the “merchant” is an ATM machine. The surcharge amount may be the amount that the acquirer 30 charges the user 10 to use the ATM 18.

After the payment processing network 40 receives the request message, the payment processing network 40 then processes the authorization request message and validates that the BIN is associated with an issuer that participates in the load process.

After the authorization request message is received by the payment processing network 40 and the payment processing network 40 validates the BIN, the request message is sent to the issuer 42 (step 212).

The issuer 42 receives and validates the request message. The issuer 42 of the portable consumer device 32 may also update a deposit account 46 associated with the portable consumer device 32, and may check the database 48 to ensure that the portable consumer device 32 participates in the load process. The issuer 42 then sends an authorization response message to the payment processing network 214 (step 214). The response message may include data elements including the account number, processing code, the amount, the expiration date, a response code, a remaining balance amount, and a network ID.

The payment processing network 40 then receives the response message and then sends the authorization response message to the ATM 18 and prepares records for settlement (step 216).

The ATM 18 then provides the user 10 with an acknowledgement for the transaction (step 218), and may thereafter return the user's portable consumer device 32 if it is in the form of a card. The ATM 18 may also provide a receipt for the user 10, or may even send an e-mail to the user 10.

After the portable consumer device 32 has been loaded with value, the user 10 may use the portable consumer device 32 at any suitable merchant just like a prepaid portable consumer device (e.g., a prepaid card). The user 10 need not carry cash in the consumer's wallet.

The acquirer, the issuer, and the payment processing network then perform a settlement process at the end of the day (step 220). In the settlement process, the transfer of actual funds between the acquirer 30 and the issuer 42 may occur.

Embodiments of the invention have a number of advantages. First, ATMs are ubiquitous, and users may easily and conveniently access an ATM to load (initially or reload) a portable consumer device with value. Second, as soon as the portable consumer device is loaded or reloaded with value, the user may then use the portable consumer. The issuer need not worry about whether or not it will receive its money if it provides the requested credit to the user, since the ATM verifies that it has received cash in the amount of the requested credit. Third, the portable consumer device may require the use of a PIN (personal identification number) before it can be used, so the reloaded portable consumer device can be better than carrying cash. For example, if the user's wallet is stolen, then any cash in the wallet is lost forever. If the reloaded portable consumer device is stolen, the value on that portable consumer device cannot be extracted by an unauthorized person without the PIN. Fourth, unlike cash, the user may have spending records tied to the portable consumer device so that the consumer can maintain spending summaries (via the issuer) using the portable consumer device.

The software components or functions described in this application, may be implemented as software code to be executed by one or more processors using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may also reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of steps disclosed in embodiment of the present invention. Based on the disclosure and teachings provided herein, a person of ordinary skill in the art will appreciate other ways and/or methods to implement the present invention.

Any recitation of “a”, “an” or “the” is intended to mean “one or more” unless specifically indicated to the contrary.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

All patents, patent applications, publications, and descriptions mentioned above are herein incorporated by reference in their entirety for all purposes. None is admitted to be prior art.

What is claimed is:

1. A method comprising:
providing tender at an automatic teller machine (ATM), the automatic teller machine being in operative communication with a payment processing network, wherein the automatic teller machine thereafter sends a transaction authorization request message to an issuer of a portable consumer device to be used by a user and wherein the issuer thereafter authorizes or does not authorize the transaction authorization request message;
receiving at the automatic teller machine, an indication that the transaction authorization request message has been approved or not approved; and
if the transaction authorization request message has been approved, the portable consumer device is either initially loaded or reloaded with an amount associated with the tender provided at the automatic teller machine.

2. The method of claim 1 wherein the transaction authorization request message is an initial load authorization request message.

3. The method of claim 1 wherein the transaction authorization request message is a reload authorization request message.

4. The method of claim 1 wherein the automatic teller machine comprises a bill reader.

5. The method of claim 4 wherein the transaction authorization request message is a reload authorization request message.

6. The method of claim 4 wherein the portable consumer device is a prepaid card, and wherein the payment processing network is adapted to process debit or credit card transactions.

7. A method comprising:
sending a transaction authorization request message to an issuer of a portable consumer device to be used by a user from an automatic teller machine (ATM) after receiving tender from a user, wherein the issuer thereafter authorizes or does not authorize the transaction authorization request message, and wherein the automatic teller machine is in operative communication with a payment processing network;
receiving at the automatic teller machine, an indication that the transaction authorization request message has been approved or not approved; and
if the transaction authorization request message has been approved, the portable consumer device is either initially loaded or reloaded with an amount associated with the tender provided at the automatic teller machine.

8. The method of claim 7 wherein the transaction authorization request message is an initial load authorization request message or a reload authorization request message.

9. The method of claim 7 wherein the transaction authorization request message is a reload authorization request message.

10. The method of claim 7 wherein the automatic teller machine comprises a bill reader.

11. The method of claim 7 wherein the transaction authorization request message includes a load amount, a BIN, and an expiration date associated with the portable consumer device.

12. A method comprising:
receiving a transaction authorization request message associated with a portable consumer device to be used by a user from an automatic teller machine (ATM), wherein an issuer of the portable consumer device thereafter authorizes or does not authorize the transaction authorization request message, and wherein the automatic teller machine is in operative communication with a payment processing network; and
sending a transaction response message to the automatic teller machine, wherein the transaction response message indicates whether or not the transaction authorization request message is approved or not approved.

13. The method of claim 12 wherein the transaction authorization request message is an initial load authorization request message or a reload authorization request message.

14. The method of claim 12 wherein the automatic teller machine comprises a bill reader.

15. An automatic teller machine comprising:
a processor; and
a computer readable medium coupled to the processor, the computer readable medium comprising code for receiving tender associated with a portable consumer device, and code for loading or reloading the portable consumer device with an amount associated with the presented tender.

16. The automatic teller machine of claim 15 further comprising a tender reader coupled to the processor.

17. A system comprising:
a portable consumer device;
an automatic teller machine, which is adapted to interact with the portable consumer device;
a payment processing network in communication with the automatic teller machine; and
a server computer residing in or in communication with the payment processing network, wherein the server computer is adapted to credit an account associated with the portable consumer device, in an amount associated with a tender presented by a user of the portable consumer device to the automatic teller machine.

18. The system of claim 17 wherein the portable consumer device is a prepaid card or a payroll card.

19. The system of claim 17 wherein the automatic teller machine has a tender reader.

20. The system of claim 17 wherein the payment processing network is adapted to process credit or debit card transactions.
